(19) United States
(12) Patent Application Publication
(10) Pub. No.: US 2003/0084376 A1
(43) Pub. Date: May 1, 2003

(54) Software crash event analysis method and system

(76) Inventors: James W. Nash, Sussex, WI (US); K. R. Shubha, Pewaukee, WI (US)

Correspondence Address: ARTZ & ARTZ, P.C., 28333 TELEGRAPH RD., SUITE 250, SOUTHFIELD, MI, 48034, US

(21) Appl. No.: 09/682,854

(22) Filed: Oct. 25, 2001

(51) Int. Cl. G06F 11/34

(52) U.S. Cl. 714/38; 714/34

(57) ABSTRACT

A method for internal analysis of crash events in software includes sending a first operation signal from a first software checkpoint to an event log. The method further includes sending a second operation signal from a second software checkpoint, which sequentially follows the first software checkpoint, to the event log. The method still further includes computing the reliability of the software from data contained in the event log.

### BACKGROUND OF INVENTION

The present invention relates generally to internal software protection and more particularly to determining the frequency of software interruptions.

A “crash” or a “hang” is a type of system failure, defined as an unplanned system unavailability or unresponsiveness due to a software failure. Measuring the frequency of software “crashes” or “hangs” in a system is difficult without external instrumentation. This is because normal flow of software operations is disrupted when the aforementioned events occur.

When the normal flow of software operations is disrupted, portions of the system designed to detect and report these events (such as “watchdog timer” designs) have a decreased probability of functioning properly because they require portions of the system to function normally after the disruption has occurred. Complex systems composed of multiple software/hardware platforms compound these difficulties.

Lack of quantitative data about the crash rate adversely affects the ability to manage the development of these systems. In other words, without fully understanding how often these crashes tend to occur as a function of usage, it is difficult to know or predict when a system will achieve an acceptable reliability through test-and-fix cycle iterations. It is also difficult to assess the impact of crash on the overall reliability of the system.

The disadvantages associated with current, software crash analysis techniques have made it apparent that a new technique for measuring and interpreting software crashes is needed. Given a program or series of programs, the new technique should allow manufacturers to rapidly and efficiently find system errors. The new technique should also allow for the calculation and analysis of software reliability data. The present invention is directed to these ends.

### SUMMARY OF INVENTION

A method for internal analysis of crash events in software includes sending a first operation signal from a first software checkpoint to an event log. The method further includes sending a second operation signal from a second software checkpoint, which sequentially follows the first software checkpoint, to the event log. The method still further includes computing the reliability of the software from data contained in the event log.

One advantage of the present invention is that it provides a software crash event measurement method. Another advantage is that it calculates software reliability statistics from crash event measurements.

Additional advantages and features of the present invention will become apparent from the description that follows and may be realized by the instrumentalities and combinations particularly pointed out in the appended claims, taken in conjunction with the accompanying drawings.

### BRIEF DESCRIPTION OF DRAWINGS

For a more complete understanding of the invention, there will now be described some embodiments thereof, given by way of example, reference being made to the accompanying drawings, in which:

FIG. 1 is a schematic diagram of a system for internal analysis of crash events in software, in accordance with a preferred embodiment of the present invention; and

FIG. 2 is a block diagram of a method for internal analysis of crash events in software, in accordance with a preferred embodiment of the present invention.

### DETAILED DESCRIPTION

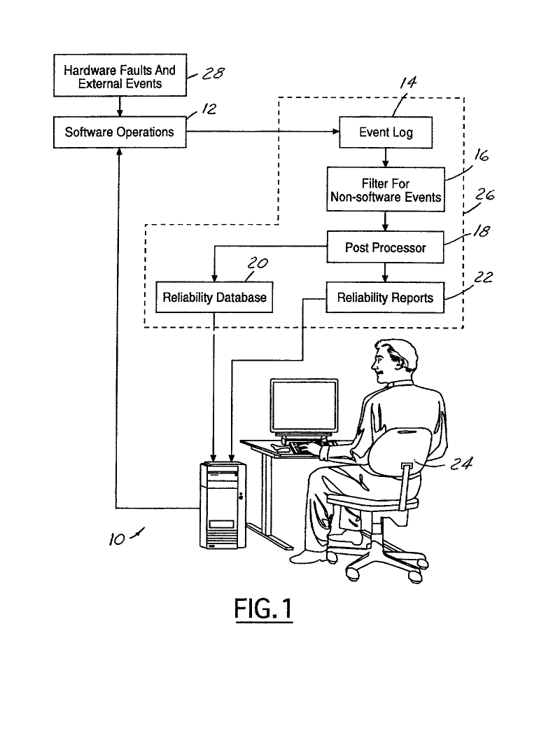

_Hlk526158799The present invention is illustrated with respect to a system for internal analysis of crash events in software, particularly suited to the field of software design. The present invention is, however, applicable to various other uses that may require internal analysis of crash events, as will be understood by one skilled in the art._Hlk526158799Referring to FIG. 1, a schematic diagram of an embodiment of a system 10 for internal analysis of crash events in software is illustrated. The system 10 includes a series of checkpoints ideally incorporated in a software program (here embodied as software operations 12), an operating system or a portion of computer hardware. The embodied software operations 12 include a controller adapted to receive the checkpoint signals and post them to the event log 14.

The checkpoints are either non-functional software checkpoints, or functional checkpoints, as in the current embodiment. Each checkpoint is adapted to send an operation signal to an event log 14, where the signal is recorded and sent through a filter 16 to a post processor 18.

The post processor 18 stores the signals in a reliability database 20 and analyzes the signals in reliability reports 22 containing an analysis logic routine. Subsequently, the reliability reports 22 are analyzed to improve the software operations and eliminate unnecessary crashes or hangs in the system 10. Typically, a software programmer 24 analyzes the data in the reliability database 20 and the reliability reports 22 after the respective software has been through a testing process. The testing process is embodied as an independent operating system 26 from the computer programmer 24, however, the programmer system and the independent operating system 26 may alternately join in a single processor where external “field” testing is not required.

In the current embodiment, checkpoint signal data is sent through a filter 16 to reduce non-software event signals. This filter 16 facilitates analysis of the software data by reducing impact on reliability statistic caused by event data from hardware faults or external events 28, as will be understood by one skilled in the art.

The currently embodied logic routine incorporates typical reliability statistics from the checkpoints and their associated times and dates. Examples of reliability statistics are “probability of boot success,” which divides the number of failed boots by the total number of boot attempts, and the “Mean-Time-Between-Failure”, which equals the number of failures during operation divided by the total operation time. It is to be understood that numerous alternate and additional probability statistics may be used, as will be understood by one skilled in the art.

The logic routine in the present embodiment is run through a post processor 18. The post processor 18 analyzes the checkpoint signals, facilitates the creation of reliability reports 22, and permanently stores the analyzed, recorded data in a reliability database 20 for future access and analysis.

Non-functional checkpoints are added to a software design for the express purpose of measuring faults or software events. For example, the “checkpoint” portion of the program may be added as an interrupt service routine that is triggered by a clock. In this alternate embodiment, the checkpoint software periodically runs and determines the state of the software by examining the CPU (Central Processing Unit) program counter, or alternately by examining data locations that mark the state of the software.

The current invention includes internal programming in the software that records the behavior of the software at functional checkpoints. The system for internal analysis of crash events in software 10 requires at least two checkpoints, however increasing the number of checkpoints increases the accuracy of the subsequent diagnosis and data analysis. The current embodiment incorporates four checkpoints: a power-up checkpoint, a power-up completed checkpoint, a shutdown checkpoint, and a shutdown completed checkpoint. These specific checkpoints were chosen because they are common points in a substantially large number of software systems, as will be understood by one skilled in the art. The ideal combination of checkpoints includes a second checkpoint that sequentially follows a first checkpoint, where an inference is made from missing data from either checkpoint, as will be discussed later.

The order that the checkpoints are recorded in the event log 14 substantially simplifies interpretation of fault data. For example, a power-up checkpoint followed by a power-up completed checkpoint indicates a successful boot. A power-up checkpoint followed by a checkpoint or signal other than the power-up completed checkpoint indicates a boot failure. A shutdown checkpoint followed by a shutdown-completed checkpoint indicates a successful shutdown. A shutdown checkpoint followed by a checkpoint or signal other than the shutdown-completed checkpoint indicates a failure during shutdown.

An additional advantage of the incorporation of checkpoints in the system 10 eliminates the former need for external monitoring equipment or external observers and thereby reduces testing-phase costs.

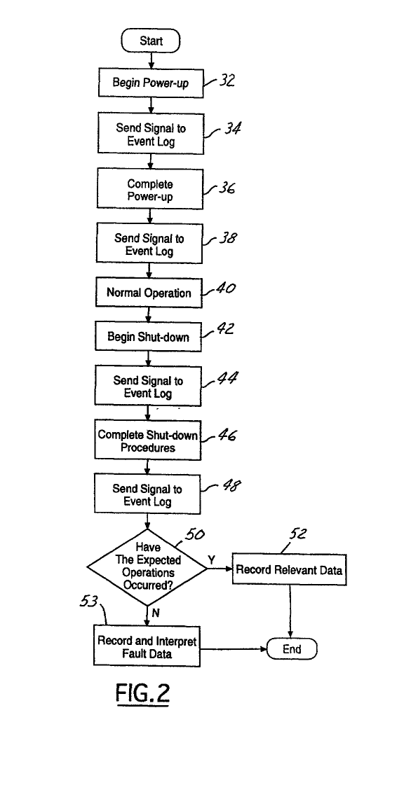

Referring to FIG. 2, a block diagram of an embodiment of a method for internal analysis of crash events in software is illustrated. Logic starts in operation block 32 where the power-up for the software program is initiated. Subsequently, in operation block 34, the software sends the power-up checkpoint signal to the event log.

Operation block 36 then activates, the software completes the power up, and sends the power-up completed checkpoint signal to the event log in operation block 38. Operation block 40 then activates, and the software program goes into normal operation, which depends on the specific functions the software was designed to perform.

Operation block 42 then activates, and the software begins the shutdown and sends the shutdown checkpoint signal to the event log in operation block 44.

Operation block 46 then activates, and the software completes shutdown and sends the shutdown completed checkpoint signal to the event log in operation block 48. At this point, the data in the event log is post processed for future storage and analysis. Additional useful steps have been included in FIG. 2 (blocks 50, 52 and 53) to demonstrate an illustrative example of one embodiment of the current invention.

After at least one full cycle of the software program, from power-up to completion of shutdown, block 50 activates; and an inquiry is made whether the expected operations have occurred. For a positive response, the post processor records the checkpoint data in the reliability database for future program modification and analysis in operation block 52.

Otherwise, operation block 53 activates, and the checkpoint data is recorded in the post processor reliability database and analyzed in the post processor reliability reports. Through this analysis, predictive statistics about the reliability of the system in the field may be generated, as will be understood by one skilled in the art. Because the event log is preserved in permanent storage, historical data can be collected from computers or software in the field to provide a more complete analysis of actual reliability performance at customer sites. Important to note is that the checkpoints are designed to measure reliability of a software application that runs in concert with an operating system, however, the checkpoint method is alternately embodied as a method for operating system crash analysis.

From the foregoing, it can be seen that there has been brought to the art a system for internal analysis of crash events in software 10. It is to be understood that the preceding description of the preferred embodiment is merely illustrative of some of the many specific embodiments that represent applications of the principles of the present invention. Numerous and other arrangements would be evident to those skilled in the art without departing from the scope of the invention as defined by the following claims.

1. A method for internal analysis of a crash event in software comprising:
sending a first operation signal from a first software checkpoint to an event log;
sending a second operation signal from a second software checkpoint sequentially following said first software checkpoint to said event log; and
computing reliability of the software from data in said event log.

2. The method of claim 1, wherein sending a first operation signal comprises sending a first operation signal from a power-up checkpoint.

3. The method of claim 1, wherein sending a second operation signal comprises sending a second operation signal from a power-up completed checkpoint.

4. The method of claim 1, wherein sending a first operation signal comprises sending a first operation signal from a shutdown checkpoint.

5. The method of claim 1, wherein sending a second operation signal comprises sending a second operation signal from a shutdown completed checkpoint.

6. The method of claim 1, wherein computing further comprises filtering said data in said event log.

7. The method of claim 1, further comprising triggering said first internal computer checkpoint and said second internal computer checkpoint by a clock as service routine interrupts.

8. A system for analyzing crash events in a computer operation comprising:
an event log;
a controller adapted to receive a first operation signal from a first internal computer checkpoint and send said first operation signal to an event log, said controller further adapted to receive a second operation signal from a second internal computer checkpoint sequentially following said first internal computer checkpoint and send said second operation signal to said event log; and
a post processor adapted to receive said first and said second operation signals from said event log, said post processor further adapted to determine a reliability indication of the computer operation as a function of said first and said second operation signals in said event log.

9. The system of claim 8, wherein said first internal computer checkpoint further comprises a power-up checkpoint.

10. The system of claim 8, wherein said second internal computer checkpoint further comprises a power-up completed checkpoint.

11. The system of claim 8, wherein said first internal computer checkpoint further comprises a shutdown checkpoint.

12. The system of claim 8, wherein said second internal computer checkpoint further comprises a shutdown completed checkpoint.

13. The system of claim 8, further comprising a filter adapted to filter said data in said event log.

14. The system of claim 8, wherein said first internal computer checkpoint and said second internal computer checkpoint comprise software checkpoints.

15. The system of claim 8, wherein said first internal computer checkpoint and said second internal computer checkpoint are service routine interrupts triggered by a clock.

16. A method for internal analysis of a crash event in software comprising:
sending a first operation signal from a power-up checkpoint to an event log;
sending a second operation signal from a power-up completed checkpoint sequentially following said power-up checkpoint to said event log;
sending a third operation signal from a shutdown checkpoint to said event log;
sending a fourth operation signal from a shut-down completed checkpoint sequentially following said shut-down checkpoint to said event log; and
computing reliability of the software from data in said event log.

17. The method of claim 16, further comprising filtering non-software events from data contained in said event log.
